(19) United States
(12) Patent Application Publication
(10) Pub. No.: US 2007/0075112 A1
(43) Pub. Date: Apr. 5, 2007

(54) Nose assembly for a fastener driving tool

(76) Inventors: Chris H. Porth, Gurnee, IL (US); Yury Shkolnikov, Glenview, IL (US); Mariam Vahabi-Nejad, Chicago, IL (US); Barry C. Walthall, Wheeling, IL (US)

Correspondence Address: LISA M. SOLTIS;ILLINOIS TOOL WORKS INC., 3600 WEST LAKE AVENUE, GLENVIEW, IL, 60026, US

(21) Appl. No.: 11/242,559

(22) Filed: Oct. 4, 2005

(51) Int. Cl. B25C 3/00

(52) U.S. Cl. 227/107

(57) ABSTRACT

A fastener driving tool includes a sleeve defining a cylinder for accommodating a reciprocating piston and a driver blade for driving a fastener into a substrate. In addition, the tool includes a nose assembly having a nosepiece associated with the sleeve and is constructed and arranged for receiving and guiding the driver blade as it drives the fastener into the substrate. The nosepiece has a body including a first component made of one material and a second component made of a second material.

### BACKGROUND

The present invention relates to an improved nose assembly for fastener driving tools, particularly those used for framing. More specifically, the present invention relates to improvements of the nosepieces for such tools.

While such tools are typically powered by pneumatic, combustion, electric, or powder systems, and the present nose assembly is contemplated as usable on fastener driving tools regardless of the power system, the main focus will be on combustion tools. Portable combustion powered fastener driving tools, such as those manufactured by ITW Paslode under the IMPULSE® brand, have been typically manufactured to operate with an integrated aluminum die cast sleeve having an attached nosepiece. Such tools incorporate a tool housing enclosing a small internal combustion engine. The engine is powered by a canister of pressurized fuel gas called a fuel cell. A battery-powered electronic power control unit produces the spark for ignition, and a fan located in the combustion chamber provides for both efficient combustion within the chamber, and facilitates scavenging, including the exhaust of combustion by-products.

The engine includes a reciprocating piston having an elongate, rigid driver blade reciprocating inside the sleeve or cylinder. Fasteners are fed to the nosepiece from a magazine where they are held in a properly positioned orientation for receiving the impact of the driver blade. Upon ignition of a gas/air-mixture, the piston/driver blade is driven down the sleeve. A leading end of the driver blade engages a fastener and drives it along a channel defined by the nosepiece into the substrate. Next, the piston and driver blade are returned to the original, pre-firing position by differential gas pressures.

The tool absorbs considerable shock and vibration during and after each actuation, in combustion tools known as a firing. In addition, the impact forces generated during fastener driving cause the tool to be propelled away from the fastener as it is driven into the substrate. These forces put large stresses on many parts of the tool, especially causing the nosepiece to wear quickly. Extended wear to the nosepiece may cause the sleeve to break or warp. When either the nosepiece or the sleeve has to be replaced because they are bent or broken, a considerable amount of time and money is required to repair the tool. This is because the nosepiece includes many parts and requires extensive and sometimes complicated disassembly.

In recent years, framing tools have become more powerful to satisfy operator needs. As a result, higher power tools generate greater stresses that weaken conventional nosepieces, causing bending or even breaking of the sleeve or nosepiece or both. Additionally, when the nosepiece bends or breaks, either the entire tool has to be discarded or the nosepiece or sleeve or both have to be replaced, which is expensive and time-consuming.

A further design factor is that higher power tools generate more heat during operation. It is believed that, in addition to operator discomfort, the heat plays a factor in premature tool breakdowns. To facilitate heat dissipation, conventional sleeves and nosepieces are made of aluminum, which has been found to be relatively more prone to impact damage.

Thus, there is a need for an improved combustion tools which addresses the above-identified design issues of impact wear, heat dissipation, and maintenance costs.

### BRIEF SUMMARY OF THE INVENTION

The above-listed needs are met or exceeded by the present improved nosepiece for an internal combustion tool. First, the nose assembly includes a nosepiece having a first component that is integral with the sleeve and made of die cast aluminum for lower tool weight and heat dissipation, and a second component preferably made of steel for durability. The present nose assembly also includes a wear plate made of steel for protecting the aluminum portion. Also the present nose assembly allows for a reduction in weight, compared to conventional nose assemblies used in pneumatic tools. By using steel to construct the nosepiece's second component and the wear plate, the durability of the nosepiece has been increased. The steel wear plate protects the aluminum second component from excessive wear and weakening generated by the higher powered framing tools.

More specifically, a fastener driving tool is provided which includes a sleeve defining a cylinder for accommodating a reciprocating piston and a driver blade for driving a fastener into a substrate. The fastener driving tool also includes a nose assembly associated with the sleeve and constructed and arranged for receiving and guiding the driver blade as it drives the fastener into the substrate. Furthermore, the present nose assembly includes a nosepiece having a body with a first component made of one material and a second component made of a second material.

### BRIEF DESCRIPTION OF THE SEVERAL VIEWS OF THE DRAWINGS

FIG. 1 is a side elevation of a framing tool with portions omitted for clarity;

FIG. 2 is an exploded, fragmentary perspective of a tool with a first embodiment of the present nose assembly;

FIG. 3 is an exploded, fragmentary perspective of a tool including a nose assembly according to a second embodiment; and

FIG. 4 is an exploded, fragmentary perspective of a tool including a nose assembly according to a third embodiment.

### DETAILED DESCRIPTION

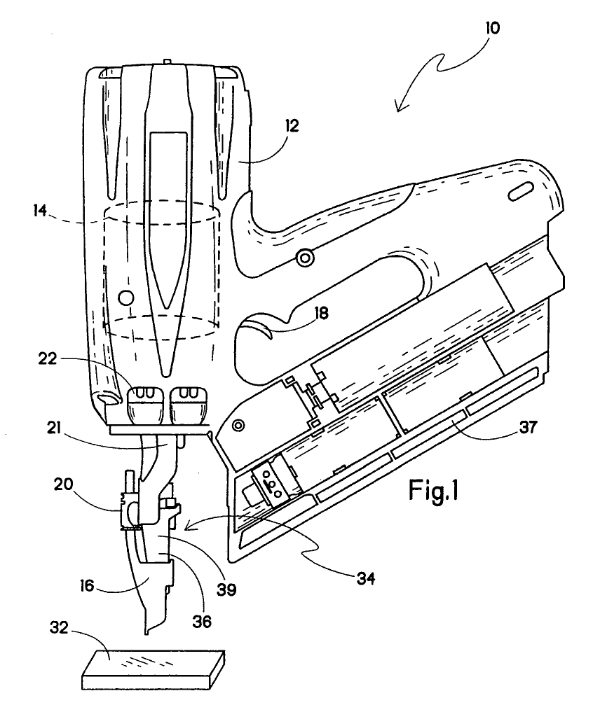

As seen in FIG. 1, a fastener driving tool is generally designated 10. Although illustrated as a combustion tool, it is contemplated that the fastener driving tool 10 may be pneumatic, electric, powder activated, or any other type of automatic fastener driving tool. The tool 10 includes a housing 12 where a combustion chamber 14 (shown hidden), among other components, is located. In addition, the tool 10 includes a workpiece contact element 16 and trigger 18. The tool 10 also includes a depth adjuster 20; which adjustably attaches an upper end of the workpiece contact element 16 and an upper probe or wire form 21 as is well known in the art.

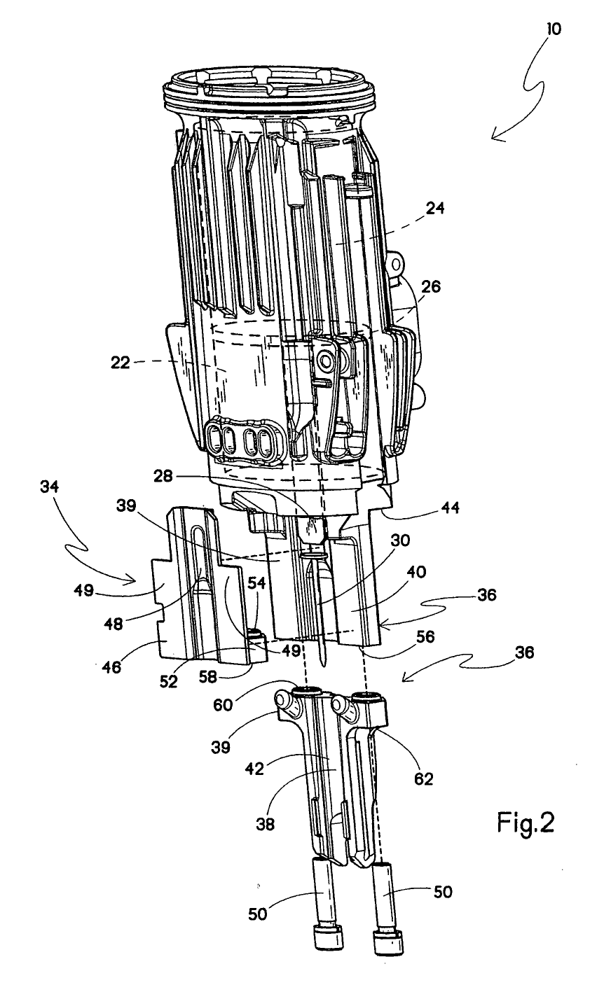

Turning to FIGS. 1 and 2, the fastener driving tool 10 of the present invention includes a sleeve 22 located within the housing 12 and defining a cylinder 24 (shown hidden) for accommodating a reciprocating piston 26 (shown hidden) and a driver blade 28. Regardless of whether the tool 10 is combustion or pneumatic powered, the piston 26 and the driver blade 28 are designed for driving a fastener 30 into a substrate or workpiece 32. The substrate 32 may be any material such as metal, wood or plastic to name just a few.

FIG. 2 depicts the present fastener driving tool 10 with a nose assembly 34 according to a first embodiment. Included in the nose assembly 34 is a nosepiece 36 that is associated with the sleeve 22. More specifically, the nosepiece 36 is constructed and arranged for receiving and guiding the driver blade 28 as it drives the fastener 30 into the substrate 32. Also, the nosepiece 36 receives fasteners 30 from a magazine 37 (FIG. 1). In most combustion powered tools, when both the workpiece contact element 16 and the trigger 18 are actuated, a gas/air mixture in the combustion chamber 14 is ignited. During combustion, the reciprocating piston 26 and driver blade 28 move axially within the sleeve 22 toward the substrate 32. As the driver blade 28 is forced out of the sleeve 22, it contacts the fastener 30 and drives the fastener along the nosepiece 36 and into the substrate 32. To facilitate this operation, the nosepiece 36 defines a channel 38 which receives and guides the driver blade 28 so that the driver blade properly drives the fastener 30.

In addition, the nosepiece 36 includes a body 39 which has a first component 40 made of one material and a second component 42 made of a second material. In the preferred embodiment, the first component 40 depends from a lower end 44 of the sleeve 22, and is preferably integral with the sleeve, being made of cast aluminum or aluminum alloy. The second component 42 is preferably made of steel, steel alloy, or other equivalent durable material and can be manufactured in any number of processes such as being cast, forged or machined. However, it is contemplated that the first component 40 is made of a separate piece and of a distinct material compared to the sleeve 22.

The use of aluminum to form the sleeve 22 is important because of aluminum's intrinsic properties. Aluminum is lighter in weight relative to its durability than many other types of metals. This is important because the sleeve 22 is such a large component relative to the overall tool 10, and using other heavier metals results in a tool that is unwieldy and uncomfortable to use and/or carry. In addition, aluminum dissipates heat quickly, which is important for maintaining operational efficiency and user comfort during extended tool operation.

The issue of tool weight arises when the sleeve 22 is constructed from several different components, because fasteners and other securing members must be used to attach all the components to each other. Also, the resulting assembly process for such tools is more complex. These problems arise frequently with pneumatic tools. In contrast, the present sleeve 22 does not suffer from these problems because the sleeve is unitarily constructed of cast aluminum, creating a lightweight yet durable component.

The depth adjuster 20 is configured for selecting the depth the fastener 30 is driven into the substrate 32, and, as is known in the art, adjusts the relative axial position of the workpiece contact element 16 with the nosepiece 36.

As seen in FIG. 2, the nose assembly 34 further includes a wear plate 46 configured for reducing wear to the nosepiece 36, especially to the first (preferably aluminum) component 40. The generally planar wear plate 46 is preferably attachable to the tool 10 between the first and second components 40, 42. Most preferably, as seen in FIG. 2, a portion of the wear plate 46 is vertically sandwiched between the first and second components 40, 42. This configuration allows the forces generated from driving the fastener 30 to be exerted on the wear plate 46 and the second component 42, instead of the less durable first component 40.

The wear plate 46 further includes a generally axially extending, radially recessed track 48 that overlies the first component 40 and is in communication with the channel 38 defined by the second component 42. The track 48 and the channel 38 provide two important functions. First, they protect the first component 40 from the forces created by driving the fastener 30. Second, the track 48 and channel 38 receive and guide the fastener 30 and the driver blade 28 along the nosepiece 34 so that the operator may accurately fire the fastener into the substrate 32.

In addition, the wear plate 46 is in registry or is flush with both the first and the second components 40, 42, so the driver blade 28 and the fastener 30 have a smooth path as they travel along the track 48 and the channel 38. It is contemplated, however, that the wear plate 46 and the second component 42 may not necessarily be in registry, specifically meaning that the track 48 is laterally displaced relative to the channel 38. This is acceptable as long as the driver blade 28 and the fastener 30 can still travel down the track 48 and, the channel 38 without losing power and accuracy. Adjacent the track 48 preferably on each side is a laterally projecting wing 49 providing support for the track and additional protection for an opposing surface of the first component 40.

The wear plate 46 is secured to, and preferably vertically between, the first and second components 40, 42 by at least one assembly fastener 50 extending along a longitudinal axis of the nosepiece 36. The assembly fastener 50 may be, for example, a screw, bolt, or any other equivalent type of securing device.

The wear plate 46 further includes a flange 52 projecting transversely from the track 48 and having at least one wear plate boss 54 for receiving the assembly fastener 50, and which is insertable into a first component counterbore hole 56 in the first component 40. At least one wear plate counterbore hole 58 passes through the flange 52 and is concentric with the wear plate boss 54. The second component 42 further includes at least one second component boss 60 which is insertable into the corresponding wear plate counterbore hole 58.

It will be seen that the first component 40, the wear plate 46 and the second component 42 are secured to each other by the at least one assembly fastener 50, which passes through a second component counterbore hole 62 and the second component boss 60, the wear plate counterbore hole 58 and the wear plate boss 54, and the first component counterbore hole 56 in an axial direction. This construction allows the wear plate 46 and the second component 42 to receive most of the impact and force when the driver blade 28 and the fastener 30 travel down the track 48 and the channel 38.

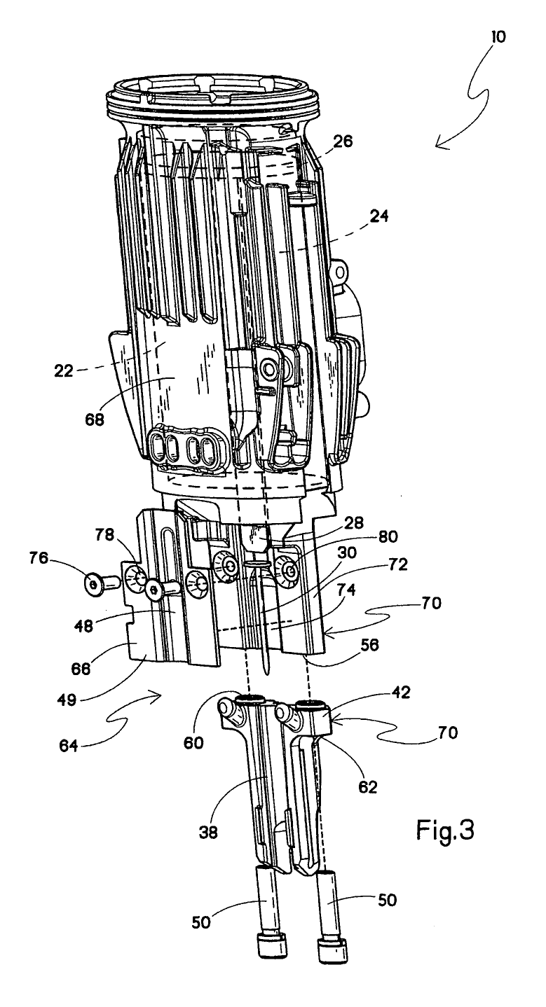

Referring to FIG. 3, a second embodiment of the present nose assembly is shown and generally designated 64 connected to the tool 10. Like reference numerals will be used to describe the like parts with respect to the first embodiment.

In the second embodiment, most of the components are substantially the same except for the nose assembly 64, a wear plate 66, a sleeve 68, a nosepiece 70, and a first component 72. As seen in FIG. 3, the wear plate 66 is configured for reducing wear to the nosepiece 70, however, the wear plate 66 is not sandwiched between the first component 72 and the second component 42. Instead, the wear plate 66 is attached to the tool 10 on a fastener receiving surface 74 of the first component 72. As in the first embodiment, the first component 72 is preferably integral with the aluminum sleeve 68. This configuration allows for easy installation or removal of the wear plate 66. More specifically, the wear plate 66 may be removed or installed without disassembling the first component 72 and the second component 42 of the nosepiece 70.

As seen in FIG. 3, the wear plate 66 is secured to the first component 72 by at least one assembly fastener 76 in a transverse direction. More specifically, the wear plate 66 has at least one attachment hole 78 and the first component 72 has a countersunk hole 80, both of which are constructed and arranged for receiving the at least one assembly fastener 76 therethrough. The assembly fastener 76 may be, for example, a screw, bolt or other equivalent type of fastener.

Another difference between the assemblies 34 and 64 is that the second component 42 is secured to directly to the first component 72 by the at least one assembly fastener 50. The assembly fastener 50 may be, for example, a screw, bolt or any other equivalent type of fastener. The boss 60 on the second component 42 matingly engages the counterbore 56 in the first component 72.

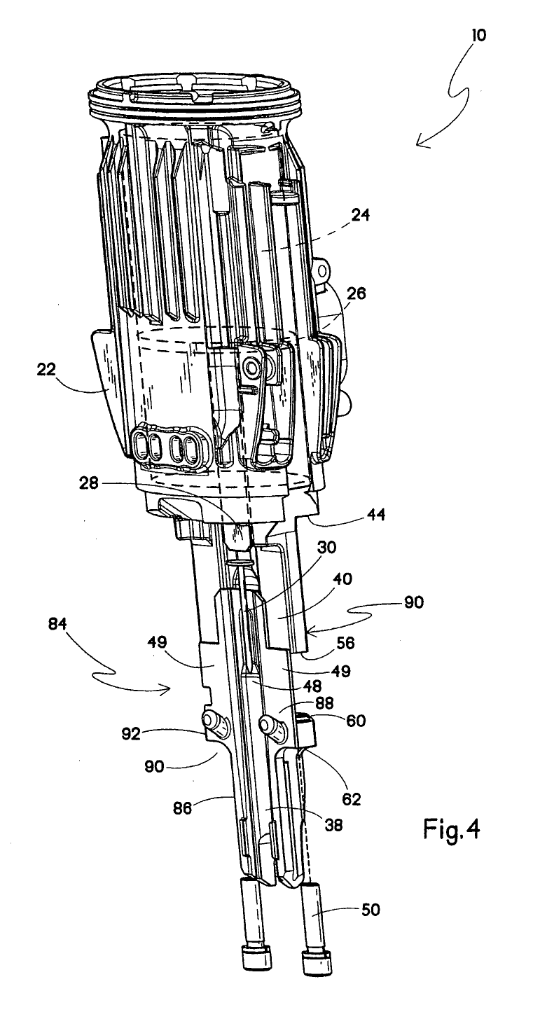

Referring to FIG. 4, a third embodiment of the present nose assembly is shown and generally designated 84 connected to the tool 10. Like reference numerals will be used to describe the like parts with respect to the first embodiment.

In the third embodiment, most of the differences between the nose assemblies 34 and 84 relate to the construction of a second component 86 and a wear plate 88, forming a nosepiece 90. As in the case of the nose assembly 34, the fasteners 50 extend along the longitudinal axis of the nose assembly 84. As seen in FIG. 4, the second component 86 and the wear plate 88 are integral with each other and form one unitary structure 92 which protects the first component 40 and the sleeve 22 from excessive wear. In addition, as in the nose assembly 34, the first component 40 is preferably integral with the aluminum sleeve 22. This configuration allows for easy installation or removal of the nose assembly 84. More specifically, the unitary structure 92 formed by the second component 86 and the wear plate 88 may be removed or installed easily by removing the at least one assembly fastener 50.

While particular embodiments of the present nose assembly for a fastener driving tool has been described herein, it will be appreciated by those skilled in the art that changes and modifications may be made thereto without departing from the invention in its broader aspects and as set forth in the following claims.

1. A fastener driving tool, comprising:
a sleeve defining a cylinder for accommodating a reciprocating piston and a driver blade for driving a fastener into a substrate; and
a nose assembly having a nosepiece associated with said sleeve and being constructed and arranged for receiving and guiding the driver blade as it drives the fastener into the substrate, said nosepiece having a body including a first component made of one material and a second component made of a second material.

2. The tool of claim 1, wherein said first component is made of aluminum and said second component is made of steel.

3. The tool of claim 2, wherein said first component is integral with said sleeve.

4. The tool of claim 1, wherein said nosepiece defines a channel for receiving and guiding the fasteners.

5. The tool of claim 4, wherein the nose assembly further includes a wear plate configured for reducing wear to said nosepiece and being attachable to said tool between said first and second components.

6. The tool of claim 5, wherein said wear plate is in registry with said second component.

7. The tool of claim 5, wherein said wear plate further includes a track in communication with said channel in said second component for receiving and guiding the fastener as said driver blade drives the fastener into the substrate.

8. The tool of claim 5, wherein said wear plate is secured to at least one of said first and second nosepiece components by at least one assembly fastener extending along a longitudinal axis of said nosepiece.

9. The tool of claim 8, wherein said wear plate is secured between said first and second components by at least one mating boss and bore.

10. The tool of claim 8, wherein said wear plate further includes a flange having at least one wear plate boss for receiving said at least one assembly fastener and which is insertable into a first component counterbore hole in said first component, said flange further includes at least one wear plate counterbore hole on a side opposite said wear plate boss, which passes through said flange and is concentric with said wear plate boss.

11. The tool of claim 10, wherein said second component further includes at least one second component boss which is insertable into a corresponding said at least one wear plate counterbore hole.

12. The tool of claim 11, wherein said first component, said wear plate and said second component are secured to each other by at least one assembly fastener which passes through at least one hole in said first component, said wear plate counterbore hole and said boss, and said second component counterbore hole in an axial direction.

13. The tool of claim 4, wherein said nose assembly further includes a wear plate configured for reducing wear to said nosepiece and being attachable to said tool on a fastener receiving surface of said first component.

14. The tool of claim 13, wherein said wear plate is secured to said first component by at least one assembly fastener in a transverse direction.

15. The tool of claim 5, wherein said wear plate includes a track for guiding fasteners, and a laterally projecting wing on either side of said track.

16. A fastener driving tool, comprising:
a sleeve defining a cylinder for accommodating a reciprocating piston and a driver blade for driving a fastener into a substrate;
a nose assembly having a nosepiece associated with said sleeve and constructed and arranged for receiving and guiding the fastener into the substrate, said nosepiece having a body including a first component made of one material and being integral with said sleeve and a second component made of a second material, wherein said nosepiece defines a channel for receiving and guiding the fasteners; and
said nose assembly further including a wear plate configured for reducing wear to said nosepiece and being attachable to said tool axially between said first and second components.

17. The tool of claim 16, wherein said wear plate is secured between said first and second components by at least one mating boss and bore.

18. A combustion powered fastener driving tool, comprising:
a sleeve defining a cylinder for accommodating a reciprocating piston and a driver blade for driving a fastener into a substrate;
a nose assembly having a nosepiece associated with said sleeve and constructed and arranged for receiving and guiding a fastener into the substrate, said nosepiece having a body including a first component made of one material and a second component made of a second material, wherein said nosepiece defines a channel for receiving and guiding the fastener; and
said nose assembly further including a wear plate configured for reducing wear to said nosepiece and being attachable to said tool on a fastener receiving surface of said first component; and
said wear plate is secured to the first component by at least one assembly fastener in a transverse direction.

19. A fastener driving tool, comprising:
a sleeve defining a cylinder for accommodating a reciprocating piston and a driver blade for driving a fastener into a substrate;
a nose assembly having a nosepiece associated with said sleeve and being constructed and arranged for receiving and guiding the driver blade as it drives the fastener into the substrate, said nosepiece having a body including a first component made of one material and a second component made of a second material; and
a wear plate configured for reducing wear to said first component upon assembly of said nose assembly to said sleeve and being integral with said second component.

20. The tool of claim 19, wherein said wear plate projects axially from said second component to overlie and cover a surface of said nosepiece of said first component.
